(19) United States
(12) Patent Application Publication
(10) Pub. No.: US 2026/0257509 A1
(43) Pub. Date: Sep. 3, 2026

(54) TACTILE LATENT INFORMATION IN AN INKJET PRINTED LAYER ON IDENTITY CARDS

(71) Applicant: IAI industrial systems B.V., Veldhoven (NL)

(72) Inventors: Iris Petronella Maria Van Gessel, Eindhoven (NL); Jurgen Kremer, Breda (NL); Marc Del Pozo Puig, Tilburg (NL)

(21) Appl. No.: 19/474,141

(22) PCT Filed: May 17, 2023
(86) PCT No.: PCT/EP2023/063281

§ 371 Date: Oct. 9, 2025

(51) Int. Cl. B42D 25/324; B42D 25/382; B42D 25/387; B42D 25/41

(52) U.S. Cl. CPC B42D 25/324; B42D 25/382; B42D 25/387; B42D 25/41

(57) ABSTRACT

Identification card (1), including a base sheet (2) and on top of said base sheet an information layer (8) containing at least one feature made of a first material, which is transparent for white light and which is or is not under irradiation with electromagnetic radiation which is not in the visible spectrum (eg UV-light or IR-light) opaque and/or colored and/or emits colored light. The feature is directly or via an intermediation of one or more layers inkjet printed on a surface of the base sheet (2) such that it protrudes therefrom. It is beneficial that the protrusion height is 2 um to 13 pm. The base sheet can have a laser engraved image.

The use of ID cards is growing in importance over the world for use as driving licenses, financial transaction or bank cards, national ID cards, student cards, passports, security clearance cards, etc.

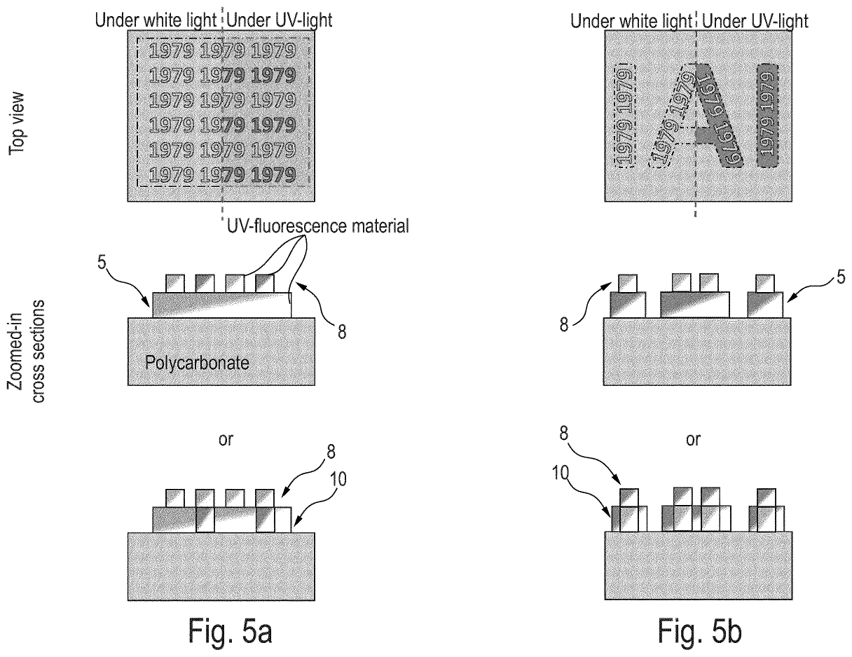

Considering the ease by which some cards can be made, there is a need for high security cards produced with advanced technology. It is important for ID documents to have clear representation of the holder's image that is also protected by layers of additional security levels. A prior art example setting up such an ID card is shown in FIGS. 5a, 5b. This prior art is MB Alfresco® Technology from the company Mühlbauer.

This technology combines color picture personalization with laser engraving. To achieve high security personalization results, the image of the holder is split into two parts by means of an as such known image processing algorithm. The converting process transfers all picture information which describe the details (forensic information) into a greyscale and color image (without picture's black components). During the pre-personalization process, the greyscale information, which contains all picture contrast information is laser engraved in the polycarbonate cards body inner layer. The picture's remaining color parts are converted to a separate color image and are inkjet printed on the blank document's surface. The final result is a high-resolution color picture, which shows utmost details and has the same long-lasting durability characteristic of more than ten years as pure laser engraved images. The high-resolution color pictures only achieved when both the inkjet printed image and the laser engrave image are correctly aligned. Because the color part of the photo is printed on the document surface, to ensure the desired long-lasting durability it has to be additionally protected by an adhesive layer, which is called protection layer or varnish layer.

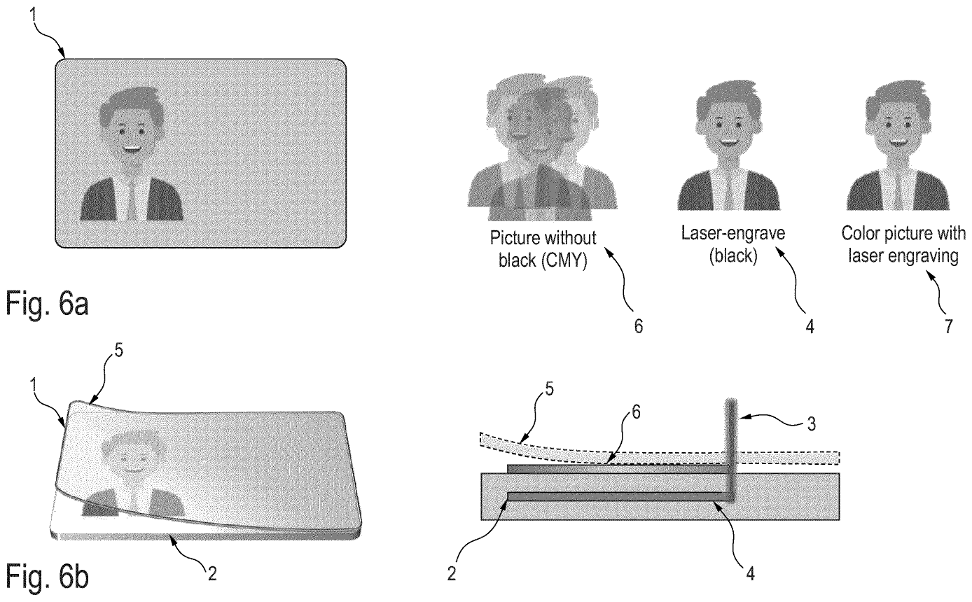

FIG. 6a shows a prior art example of the complete ID card 1. How the ID card is setup (from different layers), can be derived from FIG. 6b. There is provided a base sheet 2 which in the particular case is made of polycarbonate. Into this polycarbonate layer, there is embedded a greyscale image by laser engraving. The laser beam used for engraving is schematically shown on the right side in FIG. 6b and has reference sign 3. To this greyscale image, which is also shown on the right side of FIG. 6a, there is printed on the top surface layer of the base sheet 2 a color image without the black component 6 of the final picture. Due to superimposing of the color image without black component 6 and the laser engraved greyscale image 4, the final color image 7 is shown on the right side in FIG. 6a. This color image without black component is printed in a so-called inkjet printed layer.

Onto this layer, there is provided a protection layer 5 or varnish layer. This is usually done in the prior art by a liquid coating.

Further to the aforementioned MB Alfresco® Technology, there is known a technology called CLIP-ID from the company Veridos. An example of this technology is shown in FIG. 6. Also in this case, the base sheet 2 is laser engraved with a grey scale image 4.

In the region of the laser engraved image, there is provided a lenticular structure which is added during the lamination process. The roughness of the lenticular lens adds mechanical structure to the layer and enhances durability. On top of this lenticular structure, there is printed a color image not aligned and it is bonded in the regular way as if there would not be a lenticular structure. Thus, the photo is thereby inseparably bonded with the card material.

This makes it easy to detect manipulated ID cards either by touching them or using an infrared light.

In order to provide further features on or in the ID cards, there is also available a further development of the CLIP-ID®, which is known as CLIP-ID ECHO, in which the lenticular lens is used to engrave a certain image at an angle containing variable data from the document holder.

However, such an approach cannot be done for documents missing this lenticular lens, limiting its implementation. In such a solution, placing the variable data is in the same location as the main profile picture would compromise the readability of the image under it.

In view of this, the present invention has been made and it is a goal to add data on top of the top surface without effecting the readability of an image potentially located under it.

Thus, generally, the present invention provides a new security measure for identity cards.

In order to solve the aforementioned problem, there is provided an ID card having a base sheet. On top of that base sheet, there is provided an information layer containing at least one feature made of a first material. The feature or features contain(s) at least information which is visible due to at least small height changes and roughness changes due to the fact that the feature/s protrude from the identification card.

In particular, the features and thus the information layer are inkjet printed directly on top of a base sheet or through an intermediation of one or more layers printed on the base sheet.

The material used for the feature in the information layer is transparent for white light and may or may not be under irradiation of electromagnetic irradiation which is not in the visible spectrum opaque and/or colored and/or emits colored light.

White light is in the present sense light which is set up of a combination of electromagnetic waves of different wavelengths in the visible spectrum, in particular, white light should be understood as light in the visible spectrum and, in particular, composed of different wavelengths so that the optical appearance of the light is white. However, under such white light, the information layer is transparent (in particular transparent for the human eye). So basically, any transparent material can be used. However, under such white light, at least the information layer, namely the feature, is transparent for the human eye. Any transparent material can be used. However, as the information layer is inkjet printed after printing this feature is transparent in appearance und irradiation with white light.

It is sufficient that the feature as information layer is transparent for white light and also transparent under irradiation of electromagnetic radiation which is not in the visible spectrum. Due to the protrusions which are made by the droplets of the inkjet printing, the respective features protrude from the identification card and are under certain circumstances also visible if the used material is also transparent under irradiation of electromagnetic radiation which is not in the visible spectrum.

After printing, this ink used for the feature or features may thus not be opaque under irradiation with electromagnetic waves which are not in the visible spectrum. Alternatively or additionally, after printing, this ink may be not colored under irradiation with electromagnetic radiation which is not in the visible spectrum.

This means that, when light or another irradiation is used, which is not in the visible spectrum, this printed information can be made visible only due to boundaries or interfaces in the information layer where the refraction index changes at this interface or boundary and or the fact that the feature protrudes from the surface.

However, it is beneficial to use as first material for the feature, a material which is under irradiation with electromagnetic waves opaque and/or colored and/or emits colored light.

As long as the material emits colored light, this is also known as fluorescent. Fluorescence describes the spontaneous emission of light in response to excitation by light. Objects that emit fluorescence are called fluorophores. The fluorescence belongs to the photoluminescence, since the excitation takes place by photons. As the material may or may not be colored under the irradiation of electromagnetic radiation which is not in the visible spectrum, any color can be visible under this irradiation such as blue, red, green.

According to the foregoing discussion, when light or another radiation is used, which is not in the visible spectrum, the information provided by the feature or features in the information layer can be made more visible because due to the fact that the feature protrudes already with a certain height, at least under certain angles, the feature is visible although it may be made of a transparent material which is transparent when viewed under white light.

Color may be any color. It may also emit any color light. The emission of light is known under fluorescence, it may be UV fluorescence, however, any other fluorescence may be provided.

The aforementioned ID card has at least a base sheet. For the base sheet, any material can be used, however, it is beneficial to use a polymeric material, in particular, it is beneficial to use a thermoplastic or thermosetting material, in particular a polycarbonate material is preferentially used. This base sheet may be made of a single layer or may be made of multiple layers. The information layer may be provided directly on top of this base sheet or via intermediation of one or more further layers.

Also in the present case, there is defined an identification card. The identification card should be interpreted in the broadest sense. Examples for such identification cards are driving licenses, financial transaction or bank cards, national ID cards, student cards, passports, security clearance cards.

It is beneficial that a protrusion height of the feature from the below surface is in the range of 2 μm to 13 μm, in particular 1 μm to 5 μm. Further preferred upper and/or lower boundaries can be 4 μm, 6 μm, 7 μm, 10 μm. Any of the aforementioned values may constitute an upper or respective lower limit of the protrusion height.

A preferred roughness range of the overall surface of the feature actually measured over the area including six different protrusions is 2 μm ±0.5 Ra

As electromagnetic radiation which is not visible in the visible spectrum, UV light or IR light or a combination of UV and IR light may be used. That means, under a UV light and/or IR light source, the information contained in the information layer can be made visible further to the fact that the information is visible due to the presence of the protrusions defined be the features. Insofar as in the following it is referred to electromagnetic radiation which is not visible in the visible spectrum, as an example UV light and/or IR light is meant.

According to a further development, the information layer contains one or more or all of the following features, which are inkjet printed in the information layer: texts, letter, picture, number, QR code. This feature or these features is/are printed in or on the information layer. So, there may be a combination of any of the aforementioned features. There may be printed different or a plurality of the same letters, different or a plurality of the same words, different or a plurality of the same pictures, or different or a plurality of the same numbers.

In the information layer, there can be also provided a combination of one or more of the same or different letters with one or more of the same or different pictures with one or more of the same or different numbers. One specific feature may be provided in one layer and another feature may be provided in a different layer. The features may also be provided in the same layer.

According to a further development, the one or more or all features may be separated from each other laterally. It is in particular beneficial that there is an empty space in the lateral direction between the respective features which is not filled with any material. That may mean that just the respective features are inkjet printed on top of one layer and are free standing.

According to a further embodiment, the identification card can further comprise or not comprise a protection layer which is made of a material which is transparent for white light and which is or is not under irradiation with electromagnetic radiation which is not in the visible spectrum opaque and/or colored and/or emits colored light. This protection layer may be transparent for white light and transparent also when irradiated with electromagnetic radiation which is not in the visible spectrum in this case, the protection layer is called varnish layer. However, the protection layer preferably completely covers the base sheet of the identification card.

Alternatively to the transparent varnish layer, there may be also used a material which is transparent for white light, but which is, when irradiated with electromagnetic radiation which is not in the visible spectrum, opaque and/or colored or emits colored light.

This protection layer can be directly provided on the base sheet. This protection layer protects the base sheet. However, this protection layer may also be provided on the base sheet via an intermediation of the later described inkjet printed layer.

The protection layer may be made of the same material or a different material as the material of the feature.

The identification card may or may not have directly on top of an upper surface of the base sheet an inkjet printed layer. The inkjet printed layer may be a CMY photograph or may be any other layer which is inkjet printed. Matching to the area of the inkjet printed layer there can be on top of this inkjet printed layer the information layer, such that there is a stacking of the base sheet, the inkjet printed layer and the information layer. However, the information layer may or may not overlap with the inkjet printed layer so there may be provided an inkjet printed layer in a different region than the information layer.

The inkjet printed layer may define under white light a monochrome or a CMY color image, in particular the inkjet printed layer may be the aforementioned image with CMY color, which does not have the black component. The black component is provided in the latter described and also in the introduction section for the prior art described laser engraved image.

Alternatively or additionally, the inkjet printed layer defines under irradiation with electromagnetic radiation which is not in the visible spectrum, for example UV and/or IR light, a monochrome or CMY color image. Also in this case, under UV or IR light, this CMY color image may not have the black component which may be provided in the laser engraved image.

The base sheet may or may not contain a laser engraved image within the material of the base layer. The aforementioned inkjet printed layer and/or the information layer may be directly placed on top in an overlapping relation fully overlapping the respective laser engraved image. Alternatively, the aforementioned layers may not be placed in overlapping relationship, which means, are not overlapping with the laser engraved image. The base sheet may contain or may not contain a laser engraved image within the material of the base sheet, wherein the inkjet printed layer and/or the information layer or part thereof is placed or is not placed in an overlap relationship on top of the laser engraved image.

According to a further development, additionally to the information layer, there may be further provided a further information layer.

The further information layer is named further information layer in order to differentiate it from the already described information layer. This further information layer contains the same feature as the information layer or at least a further feature which is different, however, this feature or further feature may also be a text, letter, picture or number.

This feature or further feature may be made from the first material, i.e. the material from which the feature in the information layer is made of a second material which is a different material from the first material.

However, the second material may be transparent for white light and under irradiation with electromagnetic radiation which is not in the visible spectrum may be opaque and/or colored and/or emits colored light.

However, this feature or this further feature of the further information layer is at least laterally embedded in a layer made of a third material which is transparent for white light and which or which is not under irradiation with electromagnetic radiation which is not in the visible spectrum opaque and/or colored and/or emits colored light.

So, basically, there is a completely closed further information layer which has further information embedded therein. In this further information layer, at least, the third material is transparent for white light and for irradiation with radiation which is not in the visible spectrum, however, under white light, basically, the information layer and the further information layer are both transparent.

The respective feature or further features of the further information layer may be directly placed below a corresponding feature of the information layer. In this case, it is beneficial to use a different material for the feature or further feature in the further information layer and the feature in the information layer. It may be the case that the material used for the information corresponding to the feature in the information layer is transparent not only for white light, but also for irradiation with electromagnetic radiation which is not in the visible spectrum, i.e., for example, also transparent for UV or IR light. However, for the material used for the feature of the further information layer, which may be provided below the feature in the information layer, a material is used which is at least opaque and/or colored and/or emits colored light under irradiation with electromagnetic radiation which is not in the visible spectrum.

According to a further development, the further information layer may be placed directly below the information layer and directly on top of the base sheet or an inkjet printed layer or on top of the aforementioned protection layer.

As a further variant, the feature and/or the further feature are each made of different materials, such that a first part of the feature or the further feature is made of a material which is transparent for white light and which under irradiation with electromagnetic radiation which is not in the visible spectrum has a first color and/or emits colored light with a first color, and such that a second part of the feature or the further feature is made of a material which is transparent for white light and which under irradiation with electromagnetic radiation which is not in the visible spectrum has a second color and/or emits colored light with a second color.

Thus, the respective feature and/or the further feature each may have a first part, for example one group of numbers, letters, words, pictures or part of a picture, word, group of numbers, which is printed with a different ink than a second part of the feature. In particular, the ink used for the first part may be an ink which, after printing, is transparent for white light and is opaque and/or colored under irradiation with electromagnetic radiation which is not in the visible spectrum.

The respective features may have a second part. The ink used for the second part is transparent for white light and it is, after printing, not opaque and/or colored under irradiation of electromagnetic irradiation which is not in the visible spectrum. That means, it is also transparent under irradiation of electromagnetic irradiation which is not in the visible spectrum.

As a further development, the first part of the feature is printed with an ink, which has a first color under irradiation with electromagnetic irradiation which is not in the visible spectrum and the second part of the feature is printed with an ink, which has a second color under irradiation with electromagnetic irradiation which is not in the visible spectrum. The second color is different from the first color.

According to a further development, the information layer and/or the further information layer may have a first region which is laterally separated from a second region of the information layer and/or the further information layer. In particular, there may be an (in lateral direction) empty space between the first and second region, wherein no material of the information layer and/or the further information layer (first and/or second and/or third material) is provided. Thus, the first region is laterally separated via a region of the identification card not filled with material from the second region. The first and second regions may thus each form flat surfaces which are separated from each other.

The respective first and second region each may include the first and second material and thus are basically flat such that the second material entirely surrounds the first material defining the feature or features, however, between the first and the second region, there may be no material so that the regions of the information layer may protrude from the base sheet of the identification card.

In each of the first and second regions, there may be provided at least one feature. It may also be the case that in first region, there may be a first type of feature and in the second region, there may be a second type of feature. For example, in the first region, there may be a text or letter and in the second region, there may be a number. The respective types of features may or may not be mixed within the first and second regions.

Also in the present case, there is defined an identification card. The identification card should be interpreted in the broadest sense. Examples for such identification cards are driving licenses, financial transaction or bank cards, national ID cards, student cards, passports, security clearance cards.

The information layer or at least the feature or features in the information layer is/are inkjet printed. Thus, the first and or second material may be inkjet printed.

According to a further coordinated aspect of the invention, there is also provided a method for inkjet printing an information layer for generating an identification card.

The method comprises the steps providing a base sheet made of a thermoplastic or thermosetting polymeric material and inkjet printing the information layer or at least one or more features embedded in the information layer. All the aforementioned features in respect to the ID card may also be formulated in a method-related feature for the aforementioned method.

The materials mentioned in the aforementioned sections may be printed from different print heads.

The inks which may be used may be composed by a set of low molecular weight monomers that trigger by a photoiniatiors result in a glassy thermoset polymer network that, when applicable, fixates a pigment within it, which can be UV-fluorescence or IR-upconverter.

However, the aforementioned inks do not delimit the present invention. It is also not necessary to generate the features and the information layer via such an inkjet printing. Any other method may also be used.

The invention is in the following explained with different embodiments and the Figures therein:

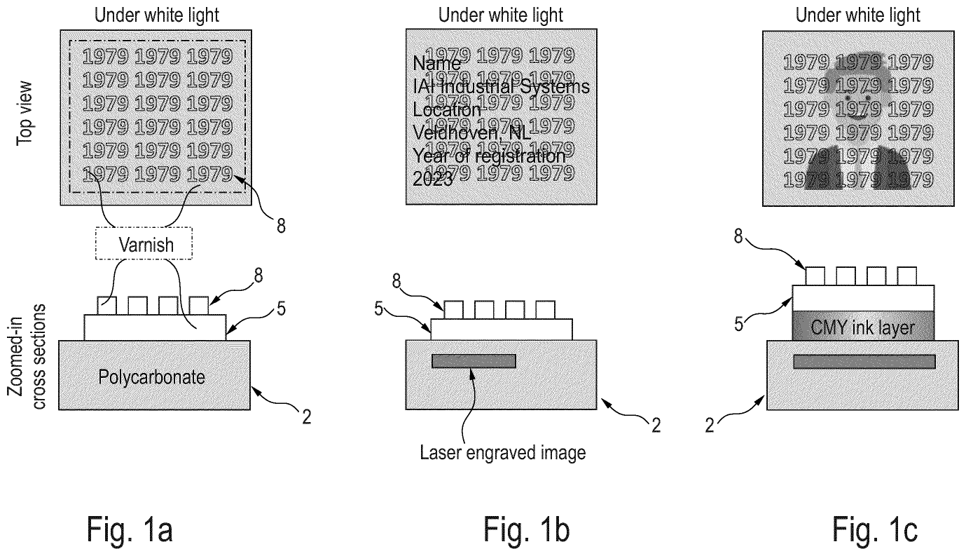

FIG. 1a shows a variant in which the information layer and thus the feature is directly printed on the varnish layer, wherein the feature is made of a material which is transparent for white light and is transparent under irradiation with electromagnetic irradiation which is not in the visible spectrum,

FIG. 1b shows a further development of the variant in FIG. 1a, wherein in the base sheet there is provided a laser engraved image,

FIG. 1c shows a further development for the second variant of FIG. 1b, in which matching to the area of the laser engraved image, there is provided an inkjet printed layer directly on top of the base sheet, on top of this inkjet printed layer, there is provided the varnish layer which is also present in the first and second variants,

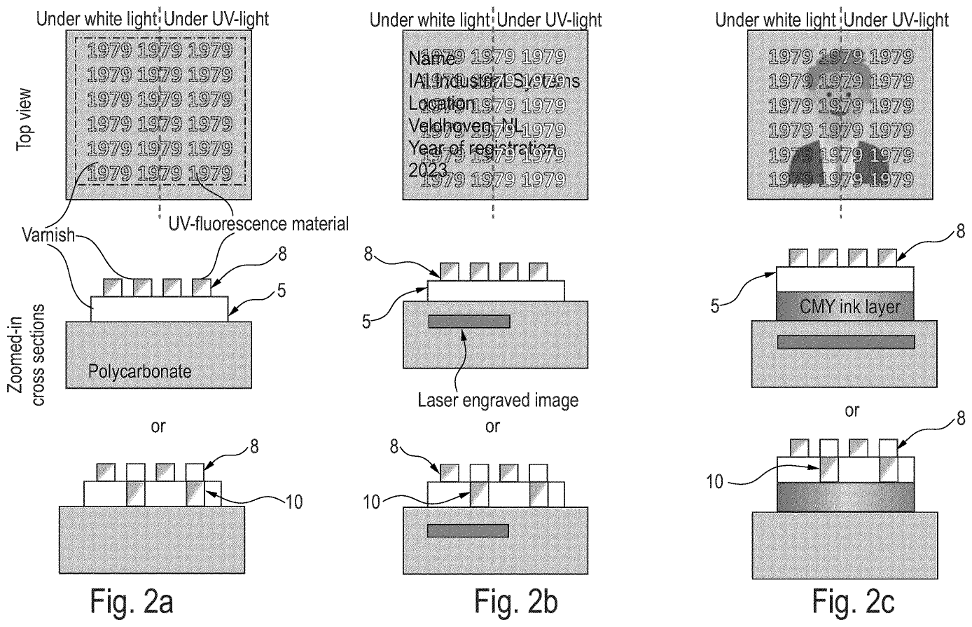

FIG. 2a shows a in the middle part thereof a variant corresponding to the first variant shown in FIG. 1a, wherein for the information layer, a UV fluorescent material is used and shows on the bottom part a further variant, wherein instead of the varnish or protection layer, there is provided a further information layer,

FIG. 2b shows corresponding variants corresponding to the variants shown in FIG. 2a, wherein further a laser engraved image is provided in the base sheet,

FIG. 2c shows corresponding variants corresponding to the variants shown in FIG. 2b, wherein an inkjet printed layer directly on top of the base sheet, on top of this inkjet printed layer, there is provided the further information layer (bottom part of FIG. 2c) or the varnish layer (middle part of FIG. 2c).

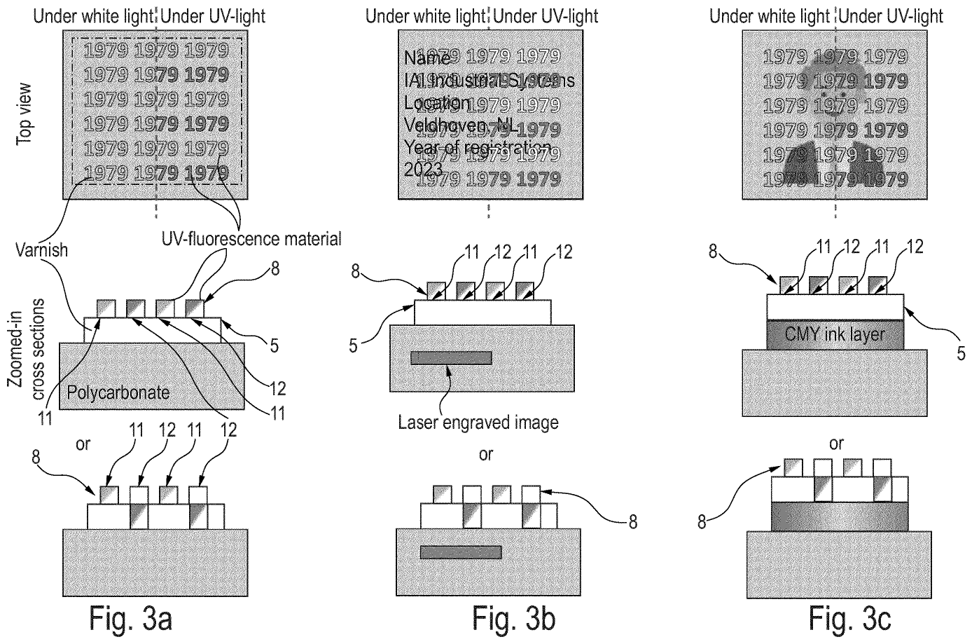

FIGS. 3a to 3c show different variants, in which for the features within the information layer or for the further features in the further information layer a different fluorescent material is used,

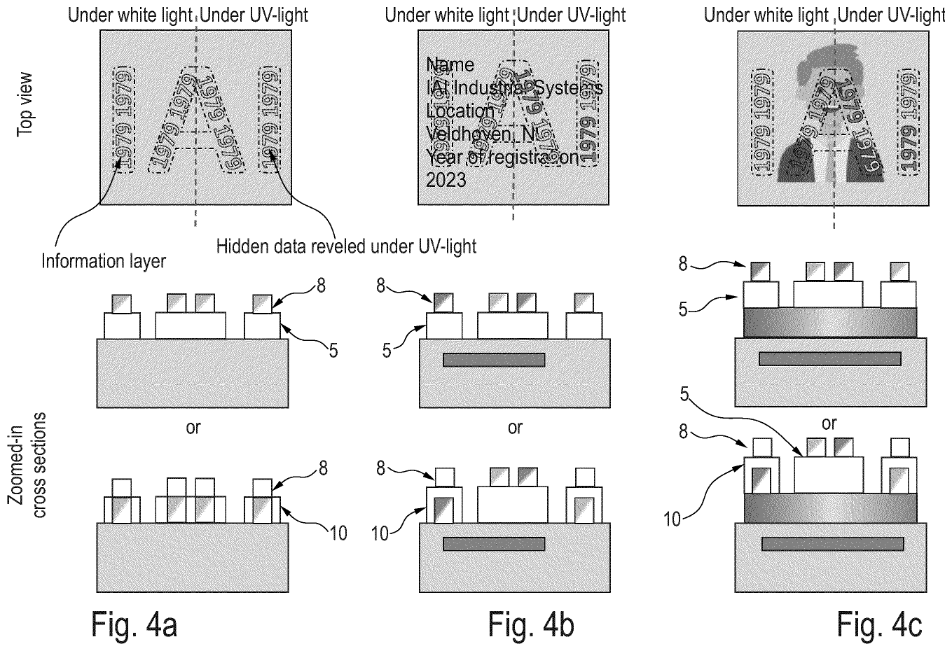

FIGS. 4a to 4c show configurations in which the information layer and the further information layer are separated in different regions which are laterally spaced from each other,

FIGS. 5a and 5b show variants concerning the further information layer,

FIGS. 6a and 6b show the prior art MB Alfresco® Technology,

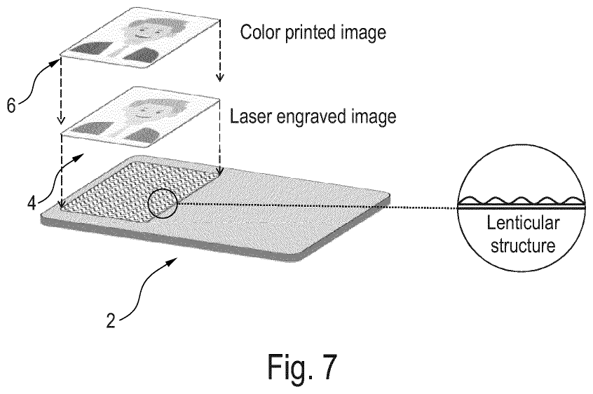

FIG. 7 shows the prior art CLIP-ID Technology,

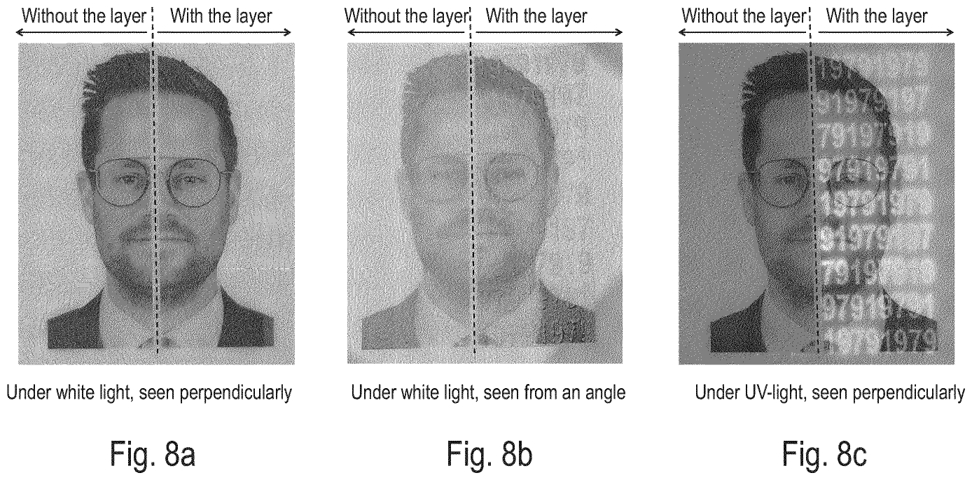

FIGS. 8a, b and c shows a test example under different views or illumination conditions, wherein on top of the printed color image there is provided the information layer which is in the particular case inkjet printed, and

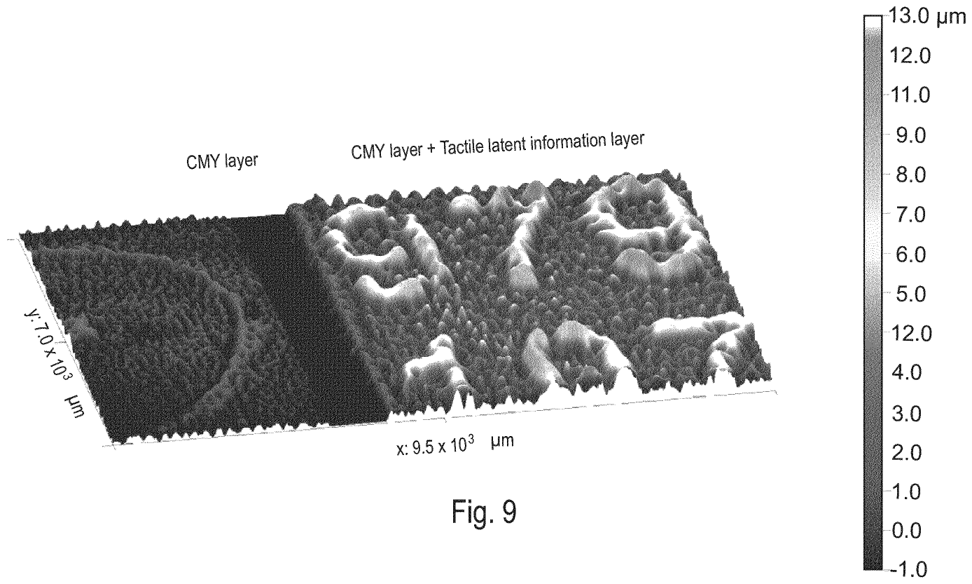

FIG. 9 shows a 3D topography of the information layer having the feature on top of an inkjet printed layer compared to a surface having an inkjet printed layer (CMY layer) thereon.

FIGS. 1a to 1c show on the upper part thereof a top view of the ID card 1, wherein in the lower part thereof, there is shown a cross-section of an example material which may define an ID card 1.

As can be derived from the cross-section, there is a base sheet 2 which is in the particular case made of polycarbonate. On top of this base sheet, there is provided in the present case a varnish layer made of a transparent material which is transparent for white light and which is also transparent when irradiated with electromagnetic irradiation which is not in the visible spectrum, e.g. UV or IR light. The varnish layer is an example of the protection layer 5 which protects the base sheet 2. However, as shown by the dotted lines on the top of FIG. 1a, the varnish layer substantially completely covers the surface of the base sheet. On top of the varnish layer, there is provided an information layer 8, which contains the respective features which are in the particular case “1979”. The numbers are grouped so that the 1979 are provided in rows and columns.

The material (first material in the claims) used for the feature of the information layer 8 is in the present case the same as the material of the varnish layer and, in particular, may be made of a material which is transparent for white light and also transparent under irradiation with electro-magnetic radiation which is not in the visible spectrum. Due to the protrusions formed by inkjet printing the features, which are made by the droplets of the inkjet printing, the respective features protrude from the identification card and are under certain circumstances also visible if the used material is also transparent under irradiation of electromagnetic radiation which is not in the visible spectrum.

As already outlined, different numbers are an example of the feature described in the general description.

The difference of the first variant shown in FIG. 1a with respect to the second variant of FIG. 1b is that in the second variant, there is further provided a laser engraved image within the base sheet. This laser engraved image is schematically shown by the dark box within the base sheet 2.

As a further development, there may be additionally provided, as shown in the third variant of FIG. 1c, a CMY inkjet layer (claims inkjet printed layer) directly on top of the base sheet 2 and matching to the laser engraved image. On top of this smooth varnish layer which covers the inkjet printed layer, there is also in the case of the third variant in FIG. 1c inkjet printed the information layer. However, for all embodiments, the features in the information layer 8 are separated from each other via a gap where no material is provided between these features.

In the variants shown in the middle portion of FIGS. 2a to 2c, the difference between the theses variants and the variants shown in FIG. 1a to c is that the information layer 8 is made of a material (first) which is transparent for white light and which, under irradiation of electromagnetic radiation which is not in the visible spectrum, is opaque and/or colored and/or emits light. In particular, the material used for the feature has a green color under UV light. Basically, these variants correspond in the other relations to the first to third variants in FIG. 1a to c.

In the lower part of FIGS. 2a to 2c, instead of the fully transparent varnish layer which serves as protection layer, there is provided a further information layer 10. This further information layer has embedded therein respective corresponding features or a further feature which is different from the feature in the information layer 8. However, the lateral space between the features in the further information layer is filled with a third material, which is transparent for white light and which under irradiation of electromagnetic radiation which is not in the visible spectrum is also transparent. Thus, there is provided one smooth layer being the further information layer and on top of this further information layer, there is provided the information layer, which is inkjet printed. The further information layer may or may not be inkjet printed.

Nevertheless, there is in theses variants used a transparent third material and for the further feature a second material which is transparent under white light and which is opaque and/or colored and emits light colored under irradiation with electromagnetic radiation which is not in the visible spectrum. Said further information layer may have the configuration of the information layer described in the PCT application PCT/EP2023/063260 (our ref. 38939.IAI.P100PC), the disclosure thereof is incorporated by reference herewith.

In the particular variants shown in the bottom part of in FIG. 2a to c, a respective feature in the further information layer is placed directly below a corresponding feature in the information layer 8.

Thus, the feature in the information layer 8, which has below thereof the feature of the further information layer is at least made of a different material than the corresponding feature in the further information layer. Thus, the feature in the information layer 8 overlapping with the feature in the lower information layer is made of a transparent material which is transparent for white light and which is transparent when irradiated with electromagnetic radiation which is not in the visible spectrum. The remaining features in the information layer, which have not a respective feature of the further information layer below, is in this example made of the same material as the feature of the further information layer and thus has under irradiation with electromagnetic radiation which is not in the visible spectrum a specific color.

The further configuration of the variants in FIGS. 2a to 2c basically correspond to the variants in FIG. 1a to c. However, the variant of FIG. 2c, bottom portion thereof, has no layer engraved image as it is provided in the variant of FIG. 1c.

The further variants shown in FIGS. 3a to 3c correspond to the respective variants in FIGS. 2a to 2c with the exception that for the variants in the middle portion of FIGS. 3a to 3 c, the material used for a first part 11 of the respective feature of the information layer 8, is different from a material used for a second part 12 of the respective feature of the information layer 8. The material used for the first part 11 of the respective feature of the information layer 8 is under UV irradiation green, the material used for a second part 12 of the respective feature of the information layer 8 is under UV irradiation red.

In the variants in the bottom portion of FIGS. 3a to 3c, the material used for a first part 11 of the respective feature of the information layer 8 is different from a material used for a second part 12 of the respective feature of the information layer 8. The material used for the first part 11 of the respective feature of the information layer 8 is under UV irradiation green, the material used for a second part 12 of the respective feature of the information layer 8 is under UV irradiation and thus under irradiation with electromagnetic irradiation which is not in the visible spectrum transparent. However, the material used for the further feature in the further information layer is further different from the aforementioned two materials for the features in the information layer 8 and is under UV irradiation red. The material used as material in the further information layer embedding the further features is the same material as the material used for a second part 12 of the respective feature of the information layer 8.

In the variants shown in FIGS. 4a to 4c, the varnish layer 5 or the further information layer 10 has a first and second region, which are laterally separated by a region in which there is no material provided.

In this case of FIGS. 4a, 4b, 4c, there is provided by varnish layer 5 or the further information layer 10 a first, second and third region which define the letters I A I on top of each of the regions, there is printed the feature of the information layer.

The difference between the variant shown in FIG. 4a in the middle and at the bottom part is that in the middle part, there is provided for the first and second region a varnish layer, which is transparent for white light and under irradiation with electromagnetic irradiation which is not in the visible spectrum, while in the bottom part, there is provided for the first and second region the further information layer. Further in the middle part, the features in the information layer are under UV irradiation green, whereas in the bottom part, the features in the information layer are under UV irradiation and thus under irradiation with electromagnetic irradiation which is not in the visible spectrum transparent, while the further features in the further information layer are under UV irradiation green.

The variants shown in FIG. 4b correspond basically to the variants shown in FIG. 4a. However, in the middle variant, the information layer 8 has the first part 11 and the second part, which have the different colors as described with respect to the variants in FIG. 3b and c (middle portion thereof).

However, in the bottom variant, the information layer 8 has the first part 11 and the second part part and a third part which three parts have the different colors. The further features in the further information layer have also a first and second part with different colors. There are patches of the varnish layer and patches of the further information layer.

Said variants shown in FIG. 4b may be combined with the situation, wherein also a CMY printed layer (inkjet printed layer) is provided which on top of the base sheet.

For the variants shown in FIG. 5a, there are used three different types of material, each having a respective different color under irradiation with UV light. In the variant in the middle portion, the protection layer has a material with a blue color under irradiation with UV light. The features in the information layer 8 correspond to the situation of the variant shown in FIG. 3b in the middle (first part and second part has green or red color under UV light irradiation).

In the variant in the bottom portion, the further information layer has a material which embeds the further features, which has a blue color under irradiation with UV light. The further features in the further information layer have a red color under UV light irradiation. The features in the information layer 8 correspond to the situation of the variant shown in FIG. 3b in the middle (first part and second part has green or blue color under UV light irradiation).

For the variants shown in FIG. 5b, there are used two different types of material, each having a respective different color under irradiation with UV light.

In the variant in the middle portion, the further protection layer has a red color under irradiation with UV light. The features in the information layer 8 have a green color under UV light irradiation. The protection layer has regions which are laterally separated from one another.

In the variant in the bottom portion; the further information layer has a material which embeds the further features and which has a bred color under irradiation with UV light. The further features in the further information layer have a green color under UV light irradiation. The features in the information layer 8 have a red color under UV light irradiation. The further information layer has regions which are laterally separated from one another.

Although in the aforementioned specific variants a specific color is described, the invention is to be understood in the broadest sense as it is described in the general description.

In FIG. 8a to c, there is shown on the respective right part of the figure (“with layer”) a test example of a variant corresponding to the variant shown in FIG. 2c. This is compared to a variant on the respective left part of the figure, where no such information layer is provided. FIG. 8a shows a situation when viewed perpendicular under white light. There is no feature visible in the information layer. FIG. 8b shows a situation when viewed from an angle under white light. There is the feature (namely the number 1979) visible because it has a certain protrusion height from the layer there below. FIG. 8c shows a situation when viewed perpendicular under UV-light. There is as feature the number 1979 visible in the information layer.

FIG. 9 shows on the right part thereof a 3D topography of the information layer having the feature on to an inkjet printed layer compared to a surface having an inkjet printed layer (CMY layer) thereon, which is shown on the left side of said image. As derivable from the right part of said figure, the feature protrudes from the surface.

It is beneficial that a protrusion height of the feature from the below surface is in the range of 2 μm to 13 μm. Further preferred upper and/or lower boundaries can be 4 μm, 6 μm, 7 μm, 10 μm. Any of the aforementioned values may constitute an upper or respective lower limit of the protrusion height.

### LIST OF REFERENCE SIGNS

1 ID-card
2 base sheet
3 laser beam
4 greyscale image
5 protection layer
6 color image without black component
7 final image
8 information layer
9 feature
10 further information layer
11 first part
12. second part

1. An identification card, comprising a base sheet and, on top of the base sheet, an information layer containing at least one feature made of a first material that is transparent for white light, wherein the at least one feature is, directly or via an intermediation of one or more layers, inkjet printed on a surface of the base sheet such that it protrudes therefrom.

2. The identification card according to claim 1, wherein a protrusion height of the at least one feature is in the range of 2 μm to 13 μm.

3. The identification card according to claim 20, wherein the electromagnetic radiation is UV-light or IR-light.

4. The identification card according to claim 1, wherein the at least one feature comprises at least one of a text, letter, picture, number, or QR Code.

5. The identification card according to claim 1, wherein there are at least two features, and at least some of the features are separated from each other laterally such that there is an empty space in a lateral direction between the features that is not filled with any material.

6. The identification card according to claim 1, further comprising a protection layer made of a material that is transparent for white light.

7. The identification card according to claim 6, wherein the information layer is printed directly on the protection layer.

8. The identification card according to claim 7, wherein the protection layer is made of the same material as the material of the at least one feature.

9. The identification card according to claim 1, further comprising an inkjet printed layer directly on top of an upper surface of the base sheet.

10. The identification card according to claim 9, wherein the inkjet printed layer defines, under at least one of white light or irradiation with electromagnetic radiation that is not in the visible spectrum, a monochrome or CMY-color image.

11. The identification card according to claim 1, wherein the base sheet contains a laser engraved image inkjet.

12. The identification card according to claim 1, wherein there is provided a further information layer, containing at least one further feature made of the first material or a second material that is transparent for white light and which, under irradiation with electromagnetic radiation that is not in the visible spectrum, is at least one of opaque, colored, or emits colored light, wherein the at least one further feature is at least laterally embedded in a layer made of a third material that is transparent for white light.

13. The identification card according to claim 1, wherein there is provided a further information layer, containing at least one further feature made of a second material that is transparent for white light, wherein the at least one further feature in the further information layer is directly placed below the at least one feature in the information layer, and wherein the second material is different than the first material.

14. The identification card according to claim 12, wherein the further information layer is placed directly below the information layer and directly on top of the base sheet or an inkjet printed layer on top of an upper surface of the base sheet.

15. The identification card according to claim 1, wherein there is provided a further information layer, containing at least one further feature made of a second material that is transparent for white light, wherein the second material is different than the first material, such that at least a part of the feature or the further feature, under irradiation with electromagnetic radiation that is not in the visible spectrum, at least one of has a first color or emits colored light with the first color, and such that at least a part of the other of the feature or the further feature, under irradiation with the electromagnetic radiation, at least one of has a second color or emits colored light with the second color.

16. The identification card according to claim 1, wherein one or both of the information layer or the further information layer has a first region, and a second region, and the first region is laterally separated, via a region of the identification card not filled with material, from the second region.

17. The identification card according to claim 16, wherein in each of the first and second regions there is provided the at least one feature or the at least one further feature.

18. The identification card according to claim 1, wherein the base sheet comprises a thermoplastic or thermosetting polymeric material.

19. A method for inkjet printing an information layer for generating an identification card, the method comprising:
providing a base sheet; and
ink jet printing, in an information layer, at least one feature made of a first material that is transparent for white light and which, under irradiation with electromagnetic radiation that is not in the visible spectrum, is at least one of opaque, colored, or emits colored light.

20. A method for inkjet printing an information layer for generating an identification card, the method comprising:
providing a base sheet; and
ink jet printing, in an information layer, at least one feature made of a first material that is transparent for white light and which, under irradiation with electromagnetic radiation that is not in the visible spectrum, is not opaque or colored, and does not emit colored light.

21. The identification card according to claim 1, wherein the first material, under irradiation with electromagnetic radiation that is not in the visible spectrum, is at least one of opaque, colored, or emits colored light.

22. The identification card according to claim 6, wherein the material of the protection layer, under irradiation with electromagnetic radiation that is not in the visible spectrum, is at least one of opaque, colored, or emits colored light.

23. The identification card according to claim 13, wherein the further information layer is placed directly below the information layer and directly on top of the base sheet or an inkjet printed layer on top of an upper surface of the base sheet.
